(19) United States
(12) Patent Application Publication
(10) Pub. No.: US 2011/0170832 A1
(43) Pub. Date: Jul. 14, 2011

(54) OPTICAL TRANSCEIVER MODULE AND METHOD OF MANUFACTURING THE OPTICAL TRANSCEIVER MODULE

(75) Inventors: Sawako Yamai, Chiba (JP); Susumu Okabe, Saitama (JP); Tsuyoshi Ito, Kanagawa (JP); Kota Asaka, Kanagawa (JP); Koji Kitahara, Kanagawa (JP); Toshio Ishikawa, Kanagawa (JP)

(73) Assignees: Fujikura Ltd., Tokyo (JP); Nippon Telegraph and Telephone Corporation, Tokyo (JP); NTT Electronics Corporation, Kanagawa (JP)

(21) Appl. No.: 12/983,984

(22) Filed: Jan. 4, 2011

(30) Foreign Application Priority Data
Jan. 8, 2010 (JP) 2010-002745

(51) Int. Cl. G02B 6/36; B23P 11/00

(52) U.S. Cl. 385/92; 29/428

(57) ABSTRACT

An optical transceiver module that is capable of being inserted into and removed from a cage includes a housing that houses a photoelectric conversion element, the housing having a guiding section formed along a front-rear direction, an operating lever that has an operating section and a lever-side contact section, the operating lever being attached to the housing in a rotatable manner about an axis of rotation; and a slider that has a wedge section that engages with a latching section provided to the cage, and a slider-side contact section that comes into contact with the lever-side contact section, the slider being guided in the front-rear direction by the guiding section, the lever-side contact section being located opposite the operating section with respect to the axis of rotation, and as the operating section is pushed rearward, the lever-side contact section pushes the slider-side contact section forward and the slider moves forward to a position where the wedge section is unlatched from the latching section.

### CROSS-REFERENCE TO RELATED APPLICATIONS

The present application claims priority upon Japanese Patent Application No. 2010-2745 filed on Jan. 8, 2010, which is herein incorporated by reference.

### BACKGROUND

1. Technical Field

The present invention relates to an optical transceiver module and a method of manufacturing the optical transceiver module.

2. Related Art

In the field of high-speed optical communications using fiber optics, optical transceivers are used as components that convert electric signals into optical signals and vice versa. In conformity with the MSA (Multi Source Agreement) established by an industry group of optical transceivers, specifications (configuration, dimensions, pin assignments, etc.,) of pluggable optical transceivers of, for example, XFP and SFP types are standardized (e.g., see SFF committee, “10 Gigabit Small Form Factor Pluggable Module”, Aug. 31, 2005 and SFF committee, “Small Form-factor Pluggable (SFP) Transceiver Multi Source Agreement (MSA)”, Sep. 14, 2000). In such pluggable optical transceivers, a cage is provided on a communication apparatus-side board (host board) and an optical transceiver module containing photoelectric conversion elements, a circuit board, etc., is inserted into the cage in a removable manner. As the transceiver module is inserted into the cage, the circuit board in the optical transceiver module will be electrically and mechanically connected to an electric interface connector in the cage. Thus, by means of the photoelectric conversion element, the circuit board, etc., in the optical transceiver module, optical signals that are transmitted and received through an optical fiber are converted into electric signals that are to be processed on the communication apparatus-side board and vice versa.

Such pluggable optical transceivers are provided with a locking mechanism, which is also referred to as a latching mechanism, to prevent the optical transceiver module from being released from the cage. The locking mechanism of the optical transceiver not only needs to secure the optical transceiver module to the cage but also needs to be capable of releasing the secured state to enable removal of the optical transceiver module from the cage. For example, U.S. Pat. No. 6,872,010 discloses a locking mechanism that is unlocked when an operating lever is rotated forward.

FIG. 15 is a diagram illustrating an optical transceiver 1′ including a locking mechanism that is unlocked when an operating lever is rotated forward.

According to such locking mechanism, lock is released as the operator rotates the operating lever forward and the optical transceiver module 1′ can be pulled out from a cage 2′. However, with such locking mechanism, in order to avoid an optical fiber from becoming an obstacle in rotating the operating lever 40′ forward, it is necessary to temporarily pull out an optical connector from a receptacle of the optical transceiver module 1′. In other words, with such a structure, it was difficult to remove the optical transceiver module 1′ from the cage 2′ with the optical fiber being connected to the optical transceiver module 1′.

In a case where such locking mechanism is applied to an optical transceiver module of a pigtail type (a type in which an optical fiber extends directly out of the optical transceiver module), since the optical fiber cannot be detached from the optical transceiver module, it is difficult to pull out the optical transceiver module from the cage.

### SUMMARY

An advantage of some aspects of the invention is to provide an optical transceiver module that can be easily attached to and detached from a cage.

According to an aspect of the invention, an optical transceiver module that is capable of being inserted into and removed from a cage includes:

a housing that houses a photoelectric conversion element, the housing having a guiding section formed along a front-rear direction;

an operating lever that has an operating section and a lever-side contact section, the operating lever being attached to the housing in a rotatable manner about an axis of rotation; and

a slider that has a wedge section that engages with a latching section provided to the cage and a slider-side contact section that comes into contact with the lever-side contact section, the slider being guided in the front-rear direction by the guiding section,

the lever-side contact section being located opposite the operating section with respect to the axis of rotation,

wherein, as the operating section is pushed rearward, the lever-side contact section pushes the slider-side contact section forward and the slider moves forward to a position where the wedge section is unlatched from the latching section.

Other aspects of the present invention shall be elucidated in the specification with reference to accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram illustrating an optical transceiver provided with a locking mechanism according to the present embodiment;

FIG. 2A is a diagram illustrating a state of a movable mechanism while being locked;

FIG. 2B is a diagram illustrating a state of the movable mechanism while being unlocked;

FIG. 2C is a diagram illustrating a state of the movable mechanism after being unlocked;

FIG. 3 is a diagram illustrating a cage;

FIG. 4 is a diagram illustrating a main body of an optical transceiver module;

FIG. 5 is a diagram illustrating a housing;

FIG. 6 is a diagram illustrating a front lower cover;

FIG. 7 is a diagram illustrating the movable mechanism;

FIGS. 8A and 8B are diagrams illustrating an operating lever;

FIG. 9 is a diagram illustrating a slider;

FIG. 10 is a cross-sectional diagram illustrating a wedge section and a vicinity thereof;

FIG. 11 is a diagram illustrating a finger grip;

FIG. 12A is a diagram illustrating a manner in which the movable mechanism is assembled;

FIG. 12B is a diagram illustrating how the movable mechanism is attached to the housing;

FIG. 13A is a top view illustrating a state in which screws are attached to first and second protruding sections, with the movable mechanism being omitted;

FIG. 13B is a top view illustrating a state in which the screws are attached to the first and second protruding sections, with only the operating lever of the movable mechanism being shown;

FIGS. 14A to 14C are diagrams illustrating variants in which FIG. 14A is a diagram illustrating a state of a movable mechanism while being locked, FIG. 14B is a diagram illustrating a state of the movable mechanism while being unlocked, and FIG. 14C is a diagram illustrating a state of the movable mechanism after being unlocked; and

FIG. 15 is a diagram illustrating an optical transceiver provided with a locking mechanism that is unlocked as the operation lever is rotated forward.

### DESCRIPTION OF EXEMPLARY EMBODIMENTS

At least the following matters will become clear through the description of the present specification and the accompanying drawings.

An optical transceiver module that is capable of being inserted into and removed from a cage includes:

a housing that houses a photoelectric conversion element, the housing having a guiding section formed along a front-rear direction;

an operating lever that has an operating section and a lever-side contact section, the operating lever being attached to the housing in a rotatable manner about an axis of rotation; and

a slider that has a wedge section that engages with a latching section provided to the cage and a slider-side contact section that comes into contact with the lever-side contact section, the slider being guided in the front-rear direction by the guiding section,

the lever-side contact section being located opposite the operating section with respect to the axis of rotation,

wherein, as the operating section is pushed rearward, the lever-side contact section pushes the slider-side contact section forward and the slider moves forward to a position where the wedge section is unlatched from the latching section.

Such optical transceiver module can be easily inserted into and removed from a cage.

It is preferable that the lever-side contact section is a claw section having a projected shape, the slide-side contact section is a window through which the claw section has been entered, and, as the operating section is pushed rearward, the claw section pushes the window and the slider moves forward to a position at which the wedge section is unlatched from the latching section. Accordingly, with the claw section pushing a front edge of the window, the slider can be moved forward.

It is preferable that the optical transceiver module further includes a finger grip having a handle section, wherein, as the operating section is pushed rearward, the finger grip moves forward by being pushed by the lever-side contact section and the handle section moves away from the housing. Accordingly, the operator can easily grasp the handle section.

It is preferable that a displacement of the finger grip as the operating section is pushed rearward is greater than a displacement of the slider. Accordingly, the operator can easily grasp the handle section.

It is preferable that the housing is provided with a projection, the operating lever being provided with a tab that goes over the projection while the operating lever is being rotated from a position where the wedge section is engageable with the latching section to a position where the wedge section is unlatched from the latching section, the tab being located on the projection while in a state where the operating section is pushed rearward and the lever-side contact section is pushing the finger grip whereas the lever-side contact section is not pushing the slider. Accordingly, unlocking can be prevented in a state where the handle section can be grasped easily.

It is preferable that the projection is a screw that is attached to the housing. Accordingly, a projection can be easily provided to the housing.

It is preferable that a head section of the screw is rounded. Accordingly, the tab can easily go over the head section of the screw and the tab can easily slide on the head section of the screw.

It is preferable that the operating lever has an axis hole and the operating lever is attached to the housing by a screw attached to the housing via the axis hole, the screw serving as the axis of rotation. Accordingly, the operating lever can be easily provided to the housing.

According to another aspect of the invention, a method of manufacturing an optical transceiver module that is capable of being inserted into and removed from a cage includes:
A) preparing a housing that houses a photoelectric conversion element, an operating lever that has an operating section, a lever-side contact section and an axis hole, and a slider that has a wedge section and a slider-side contact section,

the housing having a screw hole and a guiding section, the guiding section being formed along a front-rear direction,

the lever-side contact section being located opposite the operating section with respect to the axis hole,

the wedge section engaging with a latching section provided to the cage, the slider-side contact section coming into contact with the lever-side contact section;
B) assembling the operating lever and the slider in such a manner that the lever-side contact section and the slider-side contact section can come into contact with each other;
C) positioning the operating lever and the slider with respect to the housing with the axis hole and the screw hole being positioned with each other, the slider being guided in the front-rear direction by the guiding section; and
D) attaching a screw to the screw hole through the axis hole and attaching the operating lever to the housing in a rotatable manner about the screw.

With such manufacturing method, it becomes easier to manufacture an optical transceiver module that can be easily inserted into and removed from a cage.

### ===Overview===

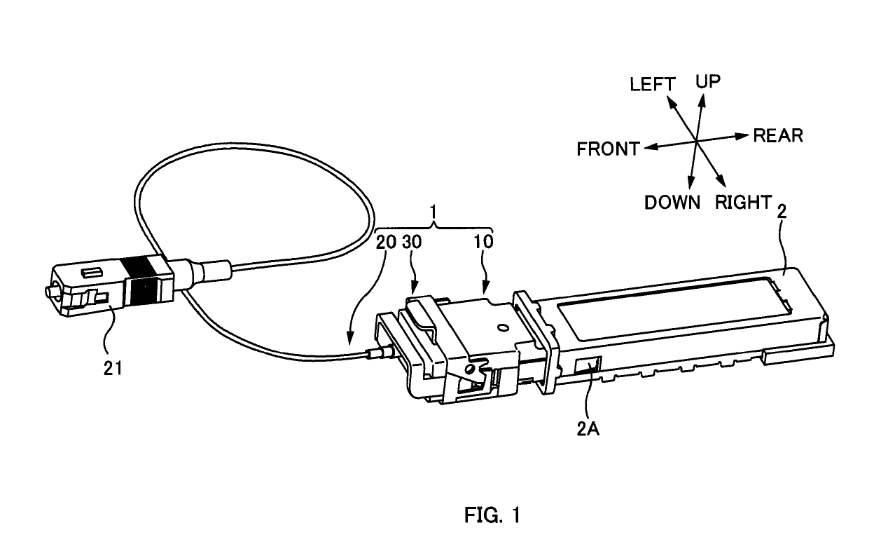

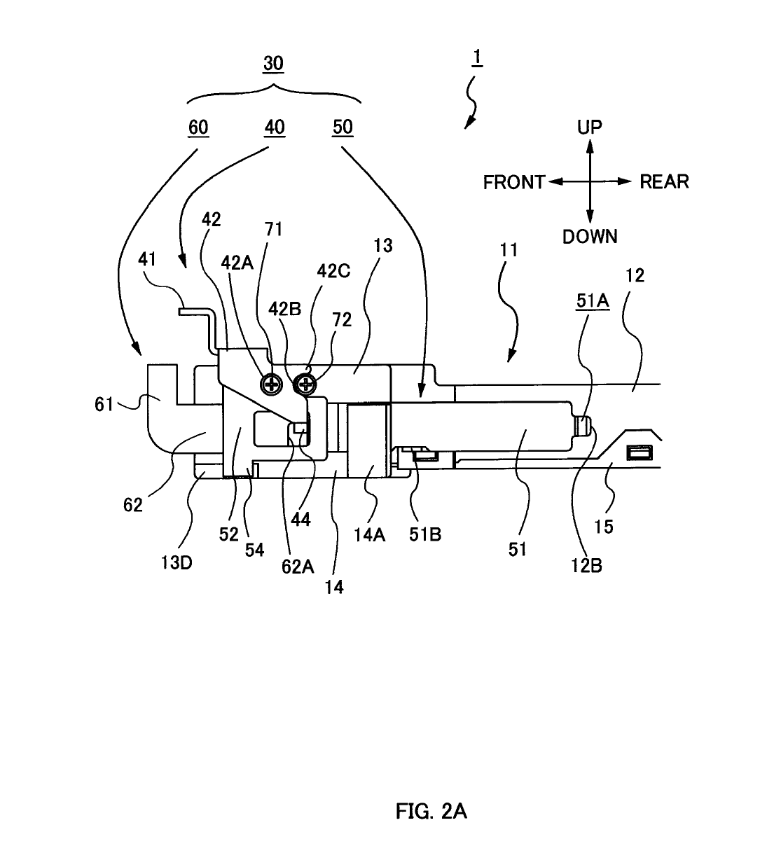

FIG. 1 is a diagram illustrating an optical transceiver provided with a locking mechanism according to the present embodiment. FIGS. 2A to 2C are diagrams illustrating movement during an unlocking operation. With regards to FIGS. 2A to 2C, an overview of the present embodiment will be described with a focus on components accompanied by underlined reference numerals.

A cage 2 is provided on a communication apparatus-side board (host board). The cage 2 accommodates an optical transceiver module 1 in a removable manner. The optical transceiver module 1 contains photoelectric conversion elements, a circuit board, etc., and converts optical signals that are transmitted and received through an optical fiber into electric signals that are processed on the communication apparatus-side board, and vice versa.

The cage 2 is provided with latching sections 2A formed at its side faces. The latching sections 2A constitute a part of a locking mechanism of the optical transceiver module (the part of the locking mechanism on the cage 2).

The optical transceiver module 1 is provided with a movable mechanism 30 that includes an operating lever 40, a slider 50 and a finger grip 60. The slider 50 of FIGS. 2A to 2C is provided with outwardly protruding wedge sections 51A at a rear end thereof. With the wedge sections 51A being engaged with the latching sections 2A of the cage 2, the optical transceiver module 1 is secured to the cage 2. Accordingly, the movable mechanism 30 including the slider 50 constitutes a part of the locking mechanism of the optical transceiver module (a part of the locking mechanism on the optical transceiver module 1). That is to say, the locking mechanism of the optical transceiver includes the latching sections 2A of the cage 2 and the movable mechanism 30 of the optical transceiver module 1.

In unlocking, the operator pushes the operating lever 40 to the rear (to the back) and causes the operating lever 40 to rotate. As a result of the rotation of the operating lever 40, the slider 50 slides to a left direction in the figure (to the front) (see FIG. 2C). As the slider 50 slides, the wedge sections 51A of the slider 50 unlatch from the latching sections 2A of the cage 2 (see FIG. 1) and a secured state of the optical transceiver module 1 is released (unlocked), resulting in a state where the optical transceiver module 1 can be pulled out from the cage 2. Since unlocking is performed by rotating the operating lever 40 rearward, an optical fiber extending from a front side of the optical transceiver module 1 will not become an obstacle during unlocking.

It is to be noted that when unlocking, as the operator pushes the operating lever 40 rearward, the finger grip 60 is urged toward the operator (to the front) (see FIG. 2B). Also, since a displacement of the finger grip 60 during unlocking is greater than a displacement of the slider 50, the finger grip 60 will project toward the operator (to the front) by a large amount. Therefore, it becomes easier for the operator to hold the finger grip 60 with his/her fingers and pull out the optical transceiver module 1 from the cage 2.

### ===Structure===

Next, a structure of the optical transceiver module will be described in detail.

In the following description, “front-rear”, “up-down” and “right-left” are defined as shown in FIG. 1. In other words, “front” is defined as a side of an insertion opening of the cage 2 whereto the optical transceiver module 1 is inserted and “rear” is defined as the opposite side. With regards to the optical transceiver module 1, “front” is defined as a side at which the movable mechanism 30 is provided and “rear” is defined as the opposite side. Further, viewing from the board on which the cage 2 is provided, “up” is defined as a side of a surface on which the cage 2 is provided and “down” is defined as the opposite side. Further, “right-left” is defined as a direction orthogonal to the front-rear direction and the up-down direction.

As shown in FIG. 1, the optical transceiver of the present embodiment includes the cage 2 and the optical transceiver module 1.

### <Cage 2>

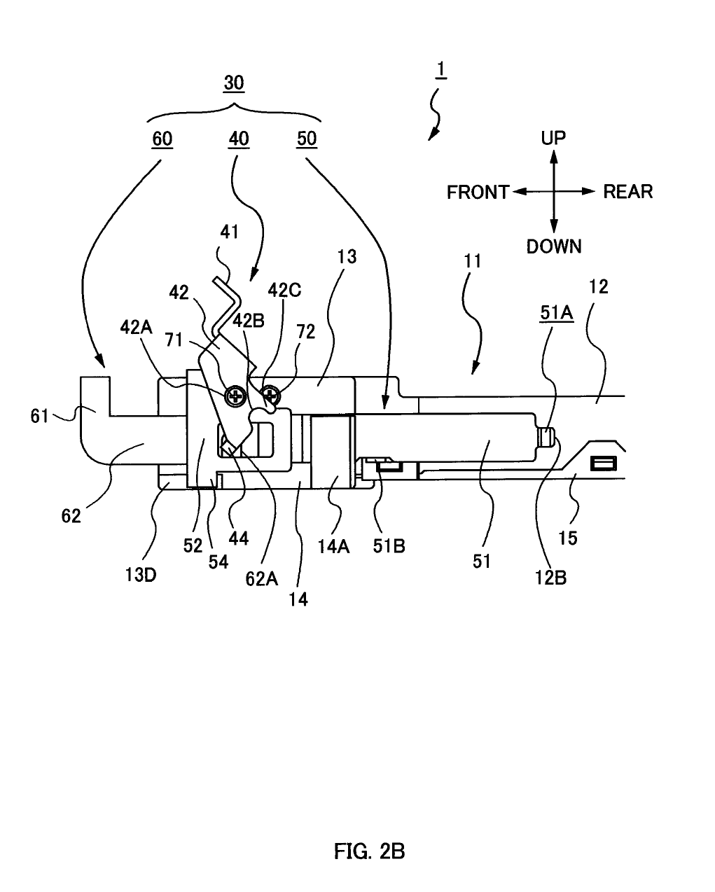

FIG. 3 is a diagram illustrating the cage 2. The cage 2 of the present embodiment is an XFP-type cage defined in MSA. The cage 2 is, for example, provided on an ONU-side board (Optical Network Unit: a communication apparatus on a subscriber side of an optical subscriber system). It is to be noted that the cage 2 may also be provided on an OLT-side board (Optical Line Terminal: a communication apparatus on a station side of an optical subscriber system).

The cage 2 is a box-like component having a rectangular cross section elongated in the front-back direction and having an insertion opening at the front into which the optical transceiver module 1 is inserted. The cage 2 is formed by bending a metal plate in such a manner that it is open at the front. With the metal plate being bent to a shape having a rectangular cross section, an accommodating section that accommodates the optical transceiver module 1 is formed inside the cage 2. At the rear of an inner section (the accommodating section) of the cage 2, an electric interface connector (not shown) is provided. Via the electric interface connector, electric signals are transmitted to and fro the optical transceiver module 1.

The latching sections 2A are formed on the side faces of the cage 2. The latching sections 2A are formed on both the right and left side faces of the cage 2 so as to conform with positions defined by MSA. The latching sections 2A are formed by slightly bending tongue-like sections stamped in a U-shape toward an inner side (a side toward the accommodating section in which the optical transceiver module 1 is to be accommodated). Since the latching sections 2A protrude toward the accommodating section side, as the optical transceiver module 1 is inserted into the cage 2, the latching sections 2A will engage with the wedge sections 51A of the slider 50 and the optical transceiver module 1 will be secured to the cage 2. Further, the latching sections 2A are elastically deformable toward an outer side. As the wedge sections 51A of the slider 50 move forward during unlocking, the latching sections 2A will escape by being elastically deformed toward the outer side.

### <Optical Transceiver Module 1>

As shown in FIG. 1, the optical transceiver module 1 includes a main body 10, a fiber optic pigtail 20 and a movable mechanism 30.

### —Main Body 10

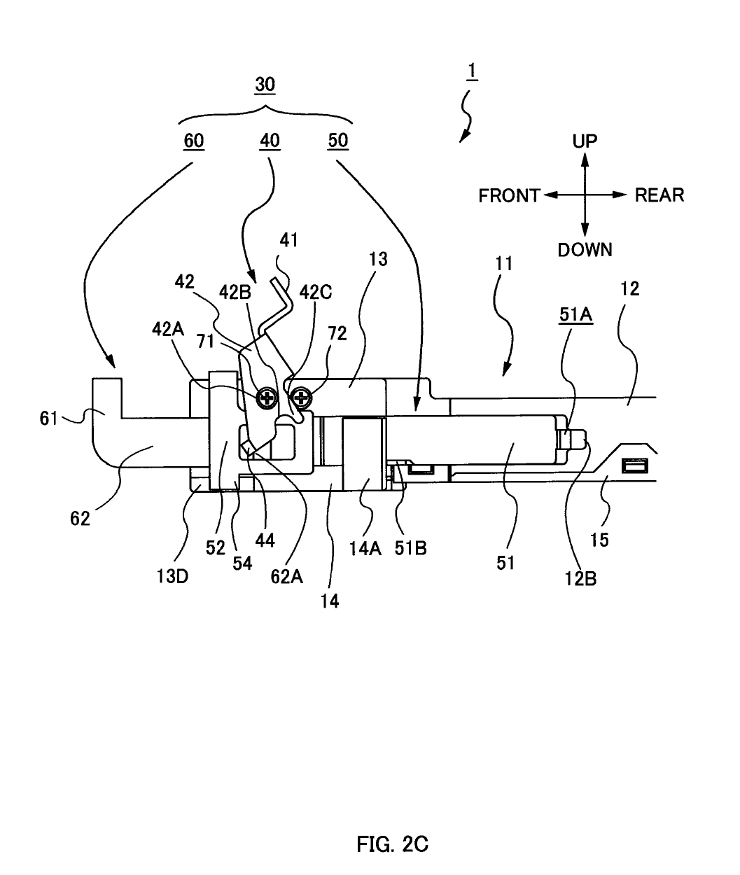

FIG. 4 is a diagram illustrating the main body 10 of the optical transceiver module 1. The main body 10 includes photoelectric conversion elements (not shown), a circuit board (not shown), a housing 11, a front lower cover 14, and a rear lower cover 15.

The photoelectric conversion elements (not shown) may include a semiconductor laser that is a light-emitting element and a photodiode that is a light-receiving element. These photoelectric conversion elements are packaged into a Bi-directional Optical Sub-Assembly which is referred to as a BOSA. Packaged into the BOSA are not only the semiconductor laser and the photodiode but also a WDM (Wavelength Division-Multiplexing) filter and a lens. The photoelectric conversion elements convert optical signals into electric signals and vice versa.

On the circuit board (not shown), a driver that drives the semiconductor laser and an amplifier that amplifies an output of the photodiode are mounted. Further, at the front of the circuit board, the BOSA is attached directly with terminal pins of the BOSA or via a flexible printed circuit board (FPC). At the rear of the printed board, a connector (not shown) is provided. As the optical transceiver module 1 is inserted into the cage 2, the circuit board of the optical transceiver module 1 will be, via this connector, electrically and mechanically connected to the electric interface connector.

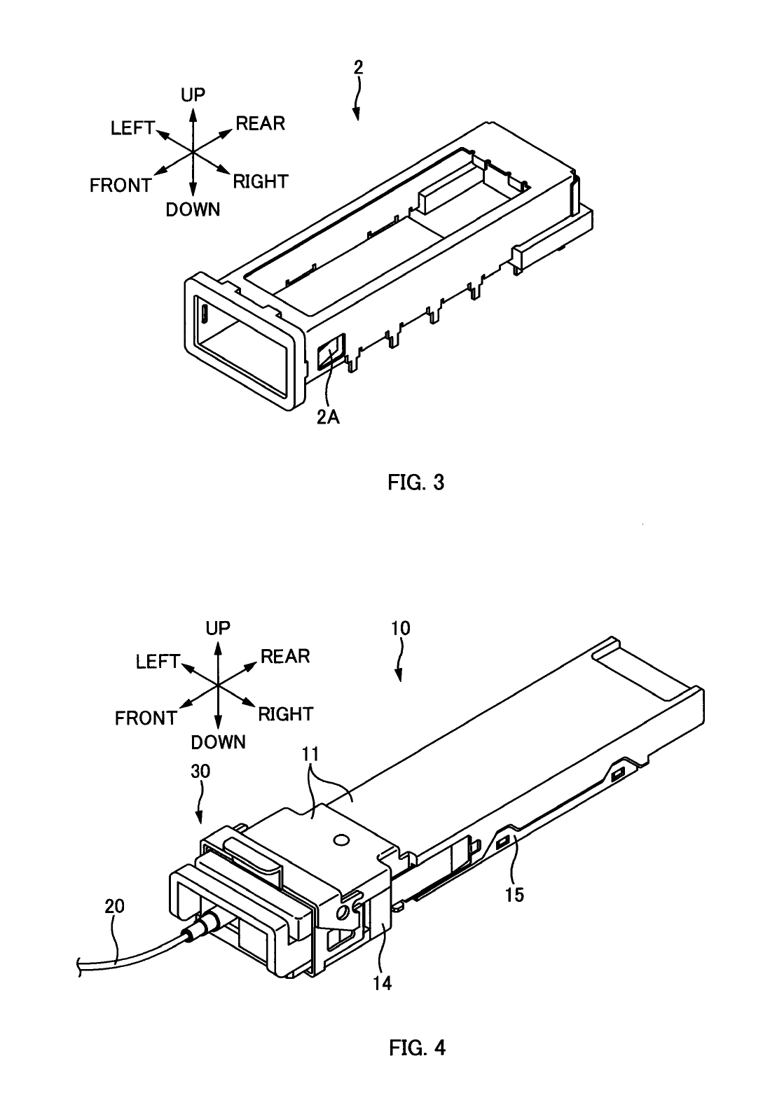

FIG. 5 is a diagram illustrating the housing 11. The housing 11 is a component that houses the photoelectric conversion elements and the circuit board (not shown). An inserting section 12 that is inserted into the cage 2 is provided at the rear of the housing 11 and a head section 13 is provided to the front of the inserting section 12. The inserting section 12 at the rear houses the circuit board and the head section 13 at the front houses the BOSA.

The inserting section 12 is provided with rear guiding sections 12A on the right and left side faces thereof. The rear guiding sections 12A are located at the front the inserting section 12 and are configured as recessed grooves along the front-rear direction. The rear guiding sections 12A guide the slider 50 (see FIGS. 1, 2A to 2C) in such a manner that a movement in the front-rear direction is enabled and a movement in the up-down direction is restricted. It is to be noted that wedge receiving sections 12B that receive the wedge sections 51A of the slider 50 are formed at the rear of the rear guiding section 12A. When the optical transceiver module 1 is inserted into the cage 2, the wedge sections 51A of the slider 50 are received at positions of the wedge receiving section 12B. Therefore, the wedge receiving sections 12B are provided on the side faces of the inserting section 12 at positions opposing the latching sections 2A of the cage 2 when the optical transceiver module 1 is inserted into the cage 2.

The head section 13A is provided with front guiding sections 13A on the right and left side faces thereof. The front guiding sections 13A are recessed grooves formed along the front-rear direction from the front to the rear of the head section 13. The front guiding sections 13A guide the slider 50 and the finger grip 60 (see FIGS. 1, 2A to 2C) in such a manner that a movement of the slider 50 and the finger grip 60 in the front-rear direction is enabled and a movement thereof in the up-down direction is restricted. In order for the slider 50 to be guided by both the front guiding sections 13A and the rear guiding sections 12A, the front guiding sections 13A and the rear guiding sections 12A have the same size in the up-down direction and the front guiding sections 13A and the rear guiding sections 12A are also at the same position in the up-down direction.

First protruding sections 13B and second protruding sections 13C are provided above the front guiding sections 13A. A screw hole is formed in each of the protruding sections. It is to be noted that the first protruding sections 13B that are located more to the front protrude more outward than the second protruding sections 13C that are located more to the rear. The reason for this will be described later.

Lower guiding sections 13D are provided at right and left of at the bottom face of the head section 13. The lower guiding sections 13D guide a lower side (hook sections 54 to be described later) of the slider 50 in the front-rear direction. For this reason, the lower guiding sections 13D have a recessed shape along the front-rear direction.

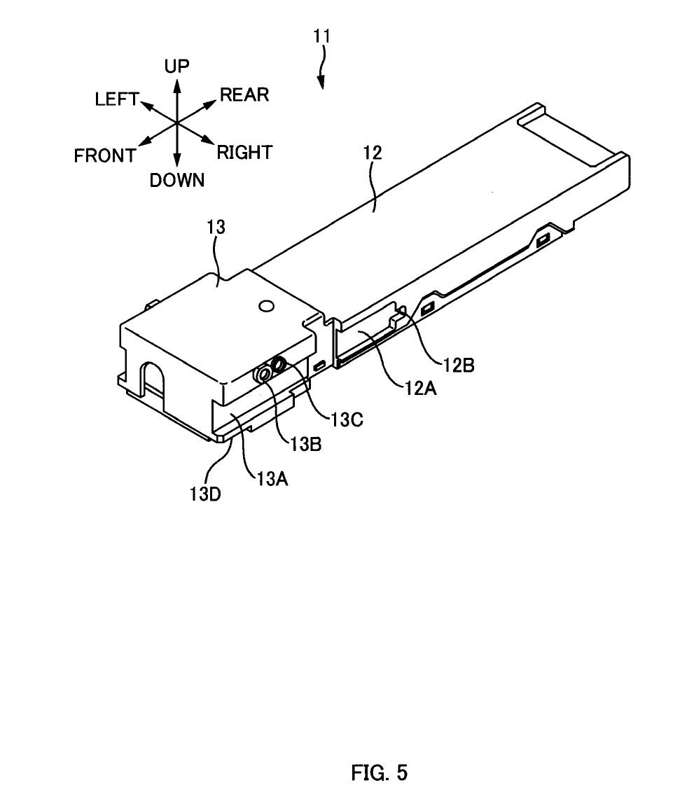

FIG. 6 is a diagram illustrating the front lower cover 14. The front lower cover 14 is a cover that is attached to the lower side of the head section 13 of the housing 11. Since the head section 13 of the housing 11 accommodates the BOSA, the front lower cover 14 also has a function of covering the BOSA.

The front lower cover 14A is provided with slider retaining sections 14A on the right and left thereof. The slider retaining section 14A retains the slider 50 of the movable mechanism 30 from outside on right and left. It is to be noted that a rear edge of the slider holding section 14A has a function of restricting a foremost position of the slider 50 (a projected section 51B of the slider 50, which will be described later, comes into contact with the rear edge of the slider holding section 14A).

The front lower cover 14 is provided with a fiber retaining section 14B at the front thereof. The fiber retaining section 14B has a function of supporting from below a fiber optic pigtail 20 that is extending from the main body 10 of the optical transceiver module 1.

The rear lower cover 15 (see FIG. 4) is a cover that is attached to a lower side of the inserting section 12 of the housing 11. Since the circuit board is accommodated in the inserting section 12 of the housing 11, the lower cover also has a function of covering the circuit board.

### —Fiber Optic Pigtail 20

The fiber optic pigtail 20 (see FIG. 1) is an optical fiber for bi-directional communication that is attached to the BOSA (Bi-directional Optical Transmission-Reception Sub-Assembly). The fiber optic pigtail 20 of the present embodiment bi-directionally transmits optical signals that have different wavelengths in a transmitting direction and a receiving direction. It is to be noted that the same wavelength may be used for transmission and reception.

The fiber optic pigtail 20 is attached to the optical transceiver module 1 in an unremovable manner. It is to be noted that the fiber optic pigtail 20 is provided with an optical connector 21 (e.g., an SC connector, see FIG. 1) attached to an end section thereof and is connectable to another optical fiber via the optical connector 21.

### —Movable Mechanism 30

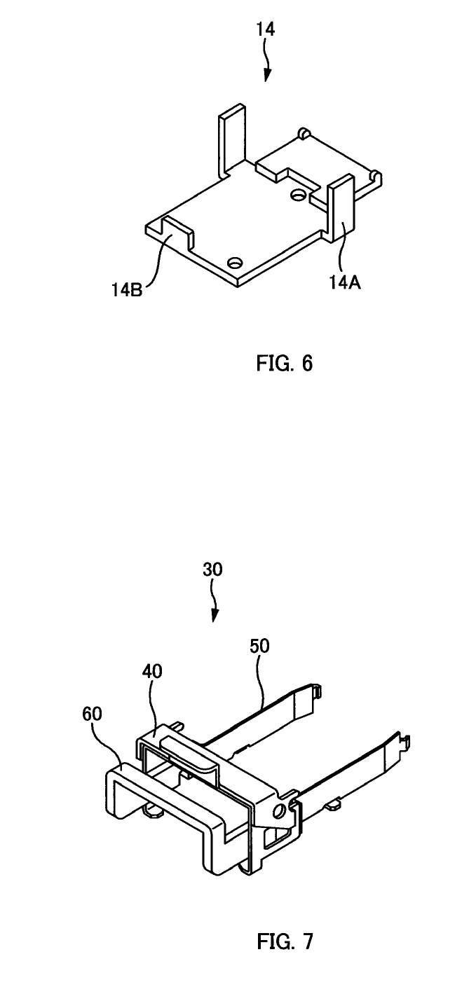

FIG. 7 is a diagram illustrating the movable mechanism 30. The movable mechanism 30 includes the operating lever 40, the slider 50 and the finger grip 60.

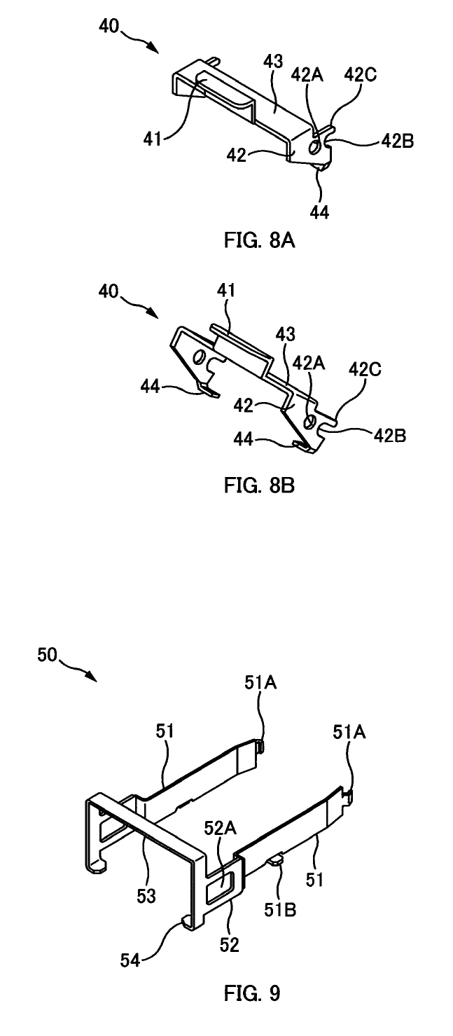

FIGS. 8A and 8B are diagrams illustrating the operating lever 40. The operating lever 40 is a component that is operated by an operator when unlocking. The operating lever 40 includes an operating section 41, side face plates 42, a lever linkage section 43, and claw sections 44. The operating section 41 is an L-shaped section located upward of the operating lever 40. This operating section 41 is pushed rearward by the operator's finger when unlocking. The lever linkage section 43 is located downward of the operating section 41 and the right and left side face plates 42 are linked via the lever linkage section 43. The side face plates 42 are provided parallel to each other in such a manner that their normals lie along the right-left direction. The claw sections 44 are provided at lower sections of the side face plates 42, respectively.

The claw sections 44 are each formed by being bent inward from the side face plate 42. By being bent inward, the claw section 44 becomes an inwardly projecting member and becomes a lever-side contact section that is to come into contact with the slider 50 (specifically, a window 52A of the slider 50).

The side face plates 42 each has an axis hole 42A, a slot 42B and a tab 42C formed thereon. The axis hole 42A is a hole that supports an axis of rotation of the operating lever 40. The axis hole 42A receives a head section of an axis screw 71 attached to the first protruding section 13B of the housing 11 and thus the operating lever 40 is attached to the housing 11 in a rotatable manner about the axis hole 42A (to be described later). The slot 42B and the tab 42C define a position of the operating lever 40. The slot 42B is formed in a recessed shape in the side face plate 42, and thus the tab 42C is formed to project from the side face plate 42 at a position adjacent to the slot 42B. It is to be noted that, during the rotation of the operating lever 40, the tab 42C moves in such a manner that it moves over the head section of the projection screw 72 attached to the second protruding section 13C of the housing 11 (described later). Accordingly, the position of the operating lever 40 is defined to a state that is either a state in which the projection screw 72 is received in the slot 42B or a state in which the lower side of the projection screw 72 comes into contact with an upper edge of the tab 42C. The tab 42C is provided at a position closer to an end section of the operating section 41 of the operating lever 40 with respect to the axis hole 42A of the side face plate 42. Therefore, in a case where the operator pushes the operating section 41, the tab 42C can easily move over the head section of the projection screw 72 (to be described later).

The claw section 44 is located opposite the operating section 41 with respect to the axis hole 42A of the side face plate 42. Therefore, when the operating section 41 moves reward in the front-rear direction, the claw section 44 moves forward in the front-rear direction (opposite to a direction of movement of the operating section 41 in the front-rear direction). The claw section 44 is provided at a position closer to an end section of the operating section 41 with respect to the axis hole 42A of the side face plate 42. Therefore, the claw section 44 is capable of applying, to other components in contact (the slider 50 and the finger grip 60), a force that is stronger than a pushing force applied to the operating section 4 by the operator 1.

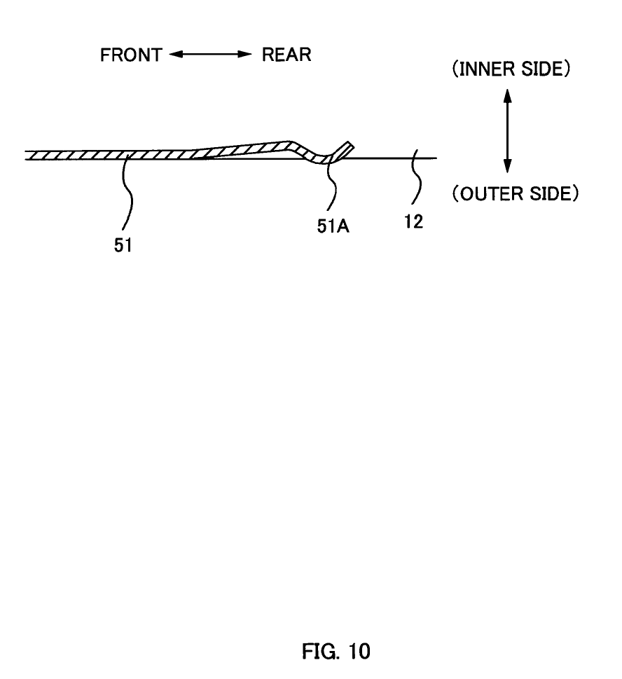

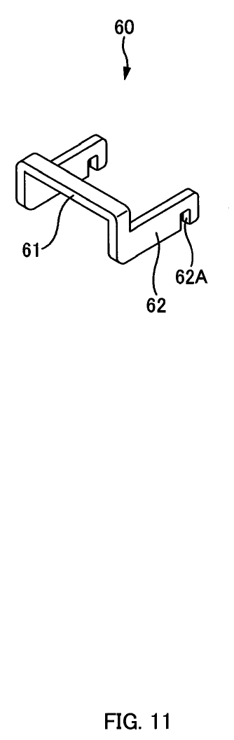

FIG. 9 is a diagram illustrating the slider 50. FIG. 10 is a cross-sectional diagram illustrating a wedge section 51A and a vicinity thereof. The slider 50 is a component that slides forward during an unlocking operation. The slider 50 includes slide plates 51, window plates 52, a slider linkage section 53 and hook sections 54.

The slide plates 51 are rectangular plate-like sections that are elongated in the front-rear direction and are located at the rear of the slider 50. The right and left slide plates 51 oppose each other with a predetermined spacing in the right-left direction. In order for the slide plate 51 to fit in the recessed groove of the front guiding section 13A and the rear guiding section 12A of the housing 11, a size of the slide plate 51 in the up-down direction is slightly smaller than the size of the front guiding section 13A and the rear guiding section 12A in the up-down direction. The slide plate 51 is provided with the wedge section 51A that protrudes outward at the rear thereof. A section of the slide plate 51 that is adjacent to the wedge section 51A of an outer side surface has a shape that is slightly recessed inward (see FIG. 10). As the latching section 2A of the cage 2 enters into the recessed section, the latching section 2A of the cage 2 engages with the wedge section 51A of the slider 50 and the optical transceiver module 1 is secured to the cage 2. The projected section 51B is provided at the lower side of the slide plate 51. The projected section 51B is formed by being bent outward from the slide plate 51. With the projected sections 51B being in contact with rear edges of the slider holding sections 14A of the front lower cover 14, the foremost position of the slider 50 will be restricted.

The window plates 52 are plate-like sections located at the front of the slide plate 51. The right and left window plates 52 oppose each other. The spacing between the right and left window plates 52 is a spacing that is wider than the spacing between the right and left slide plates 51 by a thickness of the finger grip 60 and narrower than the spacing between the right and left side face plates 42 of the operating lever 40. The window plate 52 has a rectangular window 52A formed therein. The claw section 44 of the operating lever 40 enters into the window 52A from outside. It is to be noted that the window 52A serves as a slider-side contact section that comes into contact with the claw section 44 that is serving as a lever-side contact section.

A size of the window 52A in the up-down direction is greater than a range of movement of the claw section 44 in the up-down direction during the rotation of the operating lever 40 and thus the claw section 44 does not come into contact with upper and lower edges of the window 52A. Also, a size of the window 52A in the front-rear direction is smaller than a range of movement of the claw section 44 in the front-rear direction during the rotation of the operating lever 40. Therefore, as the operating lever 40 rotates, the claw sections 44 comes into contact with the front edge or the rear edge of the windows 52A and the slider 50 moves in the front-rear direction.

The slider linkage section 53 is located at an upper side of the window plate 52, and the right and left window plates 52 are linked via the slider linkage section 53. The hook sections 54 are located at a lower side of the window plate 52. The hook sections 54 are formed by being bent inwardly from the window plates 52. Accordingly, the window plates 52, the slider linkage section 53 and the hook sections 54 of the slider 50 come into a state in which they embrace the head section 13 of the housing 11. The slider 50 is movable in the front-rear direction with the hook sections 54 being guided in the front-rear direction by the lower guiding sections 13D at the lower side of the housing 11.

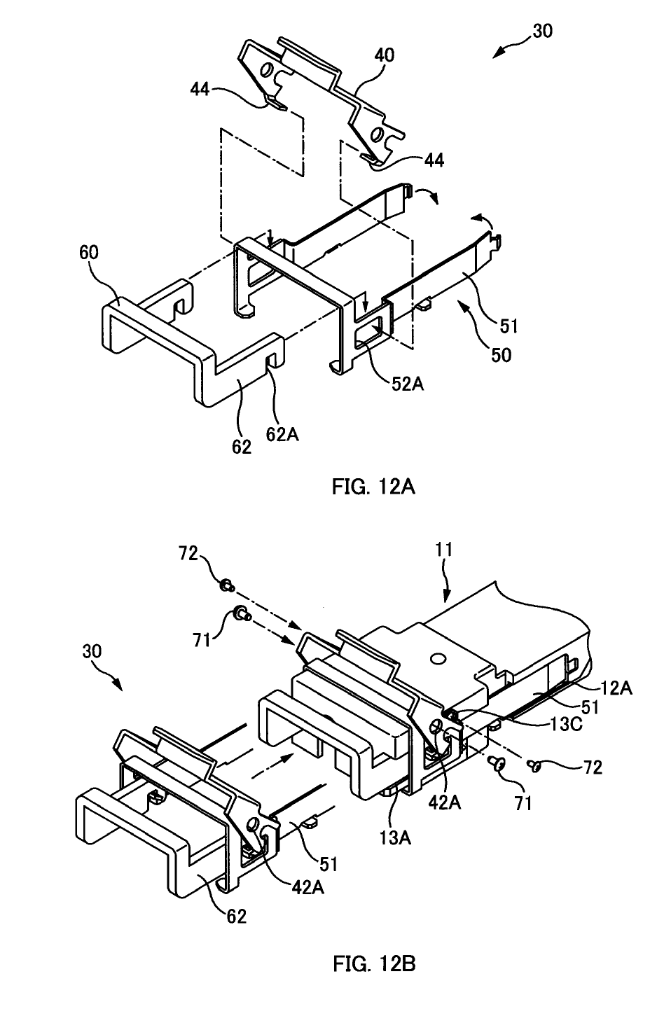

FIG. 11 is a diagram illustrating the finger grip 60. The finger grip 60 is a component that is held by the operator when pulling out the unlocked optical transceiver module 1 from the cage 2. Since a force for pulling out a card edge connector on the circuit board of the optical transceiver module 1 from a connector socket on the board on the communication apparatus side (host board) is required in pulling out the optical transceiver module 1 from the cage 2, the finger grip 60 has a greater thickness as compared to the operating lever 40 and the slider 50. The finger grip 60 has a handle section 61 and engaging sections 62.

The handle section 61 is a section to be held between the fingers of the operator. The handle section 61 is configured in such a manner that their normals to each plate face lie in the up-down direction in order that it can be easily held in the up-down direction by the thumb and the index finger of the operator.

The engaging section 62 is a section having a rectangular shape elongated in the front-rear direction. The engaging sections 62 provided on the right and left are linked with the handle section 61. The right and left engaging sections 62 oppose each other with a spacing that is substantially the same as the spacing between the right and left slider plate 51 of the slider 50. Accordingly, by utilizing the front guiding sections 13A that guide the slide plates 51, the engaging sections 62 can be guided in the front-rear direction. In order that the engaging sections 62 fit into the recessed grooves of the front guiding sections 13A of the housing 11, a size of the engaging section 62 in the up-down direction is somewhat narrower than a size of the front guiding section 13A in the up-down direction. The engaging section 62 is provided with a notched section 62A formed at the rear. The notched section 62A is a section that is recessed from the lower side of the engaging section 62. The claw section 44 of the operating lever 40 enters into the notched section 62A. It is to be noted that the notched section 62A serves as a finger grip-side contact section that comes into contact with the claw section 44 serving as a lever side-contact section.

In order to prevent the claw section 44 from coming into contact with the front and rear edges of the notched section 62A at the same time, a size of the notched section 62A in the front-rear direction is greater than a size of the claw section 44 of the operating lever 40 in the front-rear direction. It is noted that a size of the notched section 62A in the front-rear direction is shorter than a size of the window 52A of the slider 50 in the front-rear direction. Accordingly, in rotating the operating lever 40, a displacement of the finger grip 60 becomes greater than a displacement of the slider 50.

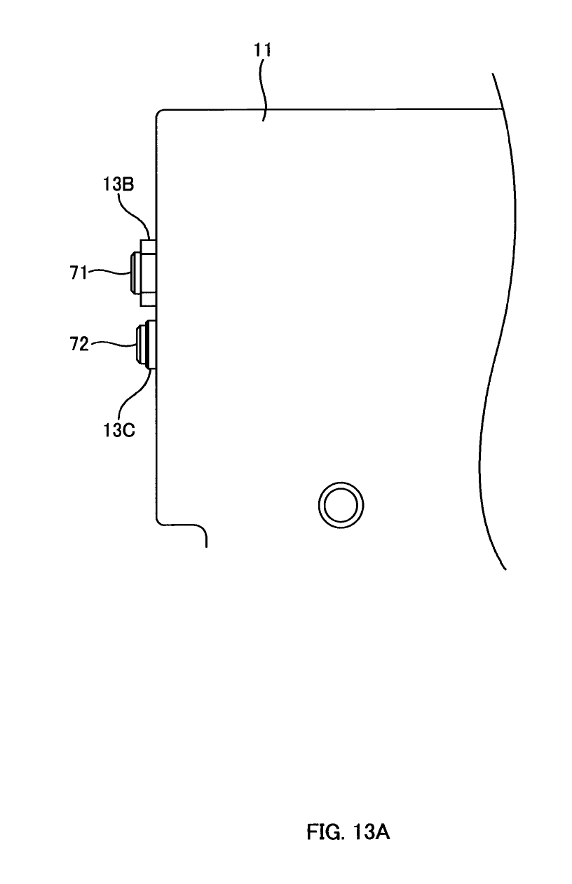

FIG. 12A is a diagram illustrating a manner in which the movable mechanism 30 is assembled.

First, the assemble worker prepares the operating lever 40 and the slider 50. Then, the worker flexes the right and left slide plates 51 of the slider 50 inwardly and fits the claw sections 44 of the operating lever 40 into the windows 52A of the slider 50. Next, the worker engages the notched sections 62A of the finger grip 60 to the claw sections 44 of the operating lever 40.

In this manner, since the finger grip 60 can be assembled by simply engaging the finger grip 60 to the claw sections 44, it is not necessary to flex the finger grip 60 as in the case of the assembling the slider 50. Since the finger grip 60 is a component that has a greater thickness than the slider 50, it is particularly advantageous that the movable mechanism 30 can be assembled without flexing the finger grip 60.

Also, since the notched sections 62A of the finger grip 60 are recessed from the lower side, the notched sections 62A can be engaged to the claw sections 44 of the operating lever 40 from above. Therefore, since the finger grip 60 is less likely to come off from the movable mechanism 30 than a case in which it engages from the lower side of the claw sections 44, an operation of attaching the movable mechanism 30 to the housing 11 is facilitated.

FIG. 12B is a diagram illustrating how the movable mechanism 30 is attached to the housing 11.

The assemble worker assembles the movable mechanism 30 and thereafter attaches the movable mechanism 30 to the housing 11. The slide plates 51 of the slider 50 and the engaging sections 62 of the finger grip 60 are attached to the housing 11 in such a manner that they are fitted into the recessed grooves of the front guiding sections 13A and the rear guiding sections 12A on the side faces of the housing 11. Then, the worker positions the axis holes 42A in the operating lever 40 to the first protruding sections 13B of the side faces of the housing 11 and attaches the axis screws 71 to the first protruding sections 13B (not shown in FIG. 12B. See FIG. 5) via the axis holes 42A. In this manner, the movable mechanism 30 is attached to the housing 11. Also, the worker attaches the projection screws 72 to the second protruding sections 13C of the side faces of the housing 11.

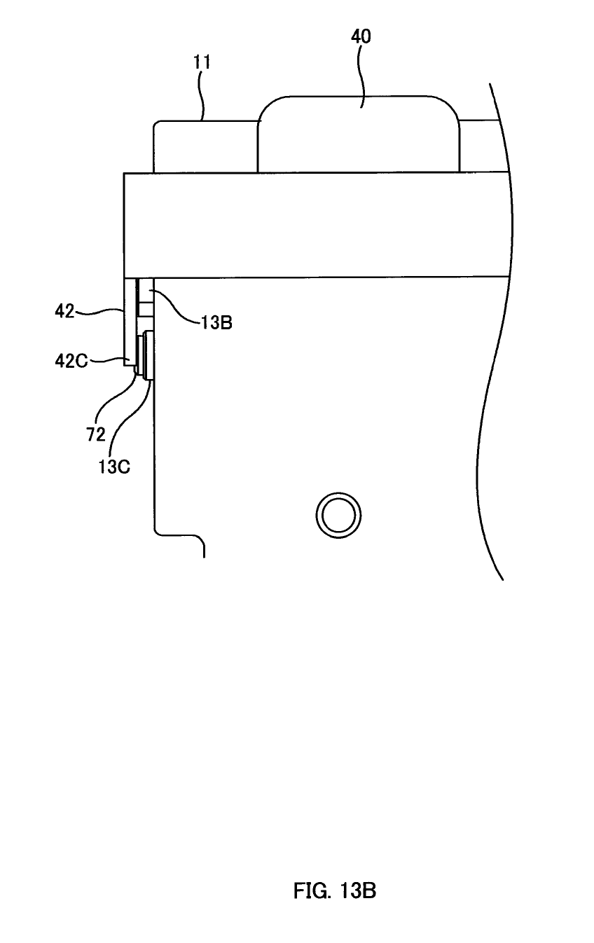

FIG. 13A is a top view illustrating a state in which screws are attached to the first protruding section 13B and the second protruding section 13C with the movable mechanism 30 being omitted. FIG. 13B is a top view illustrating a state in which the screws are attached to the first protruding section 13B and the second protruding section 13C with only the operating lever 40 of the movable mechanism 30 being shown.

As shown in the drawings, with the axis screw 71 being attached to the first protruding section 13B, a head section of the axis screw 71 protrudes more outwardly than the first protruding section 13B. Then, since the head section of the axis screw 71 is fitted to the axis hole 42A of the operating lever 40, the movable mechanism 30 is attached to the housing 11 in a state where the operating lever 40 is rotatable about the head section of the axis screw 71 that is serving as an axis of rotation.

In the present embodiment, since the axis screw 71 is attached after the movable mechanism 30 has been positioned with respect to the housing 11, the movable mechanism 30 can be attached to the housing 11 easily. If it is attempted to attach the movable mechanism 30 with the axis screws 71 being attached to the housing 11 in advance, it would be necessary to fit the head sections of the axis screws 71 into the axis holes 42A while pushing the right and left side face plates 42 of the operating lever 40 outwardly and thus it would be difficult to attach the movable mechanism 30 to the housing 11. In such a manner, in order to facilitate attachment of the movable mechanism 30 to the housing 11, the present embodiment is directed to a configuration in which the head section of the axis screw 71 serves as the axis of rotation of the operating lever 40.

An mount of outward protrusion of the second protruding section 13C is smaller than that of the first protruding section 13B. Since screws of a same type (pan head screws) are used for the axis screw 71 and the projection screw 72, an amount of outward protrusion of the projection screw 72 attached to the housing 11 will be smaller than that of the axis screw 71. As a result, with respect to a position of an inner surface of the side face plate 42 of the operating lever 40, almost an entirety of the head section of the axis screw 71 will be situated on an outer side and only a part of the head section (specifically, a part in which a corner of the head section of the pan head screw is rounded) of the projection screw 72 will be situated on the outer side. Accordingly, in FIG. 13B, almost an entirety of the head section of the axis screw 71 is hidden by the side face plate 42 and only a part of the head section of the projection screw 72 is hidden. Accordingly, the tab 42C can go over the head section of the projection screw 72 when the operating lever 40 is rotated. It is to be noted that, since a pan head screw having a rounded head section is used as the projection screw 72, the tab 42C can easily go over the head section of the projection screw 72.

After the movable mechanism 30 has been attached to the housing 11, the BOSA and the circuit board are housed in the housing 11. Then, after having housed the circuit board, etc., into the housing 11, the front lower cover 14 and the rear lower cover 15 are attached to the housing 11 and the optical transceiver module is completed.

### ===Unlocking===

Next, an operation during unlocking will be described in detail with reference to FIGS. 2A to 2C. The cage 2 is not illustrated in the drawings to facilitate explanation.

### <During Locking>

FIG. 2A is a diagram illustrating a state of a movable mechanism while being locked.

The operating lever 40 is in a state where it is rotated most forwardly. In this state, the operating lever 40 is not in contact with the optical fiber that is extending from the front side of the optical transceiver module. Therefore, the operating lever 40 will not rotate forward any further and thus will not come into contact with the optical fiber. The claw sections 44 of the operating lever 40 are at the rear most position within a moving range in the front-rear direction. The head sections of the projection screws 72 are fitted in the slots 42B of the operating lever 40. Also, the lower side of the tabs 42C of the operating lever 40 is in contact with the upper side of the projection screws 72. In order for the operating lever 40 to rotate, the tabs 42C need to go over the head sections of the projection screws 72, and therefore, unless an external force is applied to the operating lever 40 from the rear, the position of the operating lever 40 is stable in this state. (It is to be noted that, in this state, even if an external force is applied to the operating lever 40 from the front, the slider 50 cannot move rearward any further and thus the operating lever 40 will not move forward).

The slider 50 is in a state where it is situated at the rearmost. The wedge sections 51A of the slider 50 are in a state where they are situated at the rearmost and they are at positions of the wedge receiving sections 12B of the housing 11. At this time, the latching sections 2A of the cage 2 and the wedge sections 51A of the slider 50 are engaging and the optical transceiver module 1 is secured to the cage 2. Since the slide plates 51 of the slider 50 are at the rearmost positions of the rear guiding sections 12A of the housing 11 and the wedge sections 51A of the slider 50 is situated at the wedge receiving sections 12B of the housing 11, the slider 50 cannot move rearward any further. Also, since the position of the operating lever 40 is stable in a state where the rear edges of the claw sections 44 of the operating lever 40 and the rear edges of the windows 52A of the slider 50 are in contact, the slider 50 is also stable at this position unless an external force is applied to the operating lever 40.

The finger grip 60 is also in a state where it is situated at the rearmost. The positions of the notched sections 62A of the finger grip 60 are restricted by the claw sections 44 of the operating lever 40. Since the position of the operating lever 40 is stable in this state, the finger grip 60 moves only to an extent of a clearance between the notched sections 62A and the claw sections 44 unless an external force is exerted on the operation lever 40.

Since the finger grip 60 is situated at the rearmost, the handle section 61 of the finger grip 60 is in a state where it is nearest to the head section 13 of the housing 11. Therefore, even if the operator attempts to grasp the handle section 61, the head section 13 will be an obstacle and it is difficult to grasp the handle section 61. Particularly, since the operating section 41 of the operating lever 40 is close to and above the handle section 61, the operating section 41 of the operating lever 40 will be an obstacle and it is difficult for the operator to grasp the handle section 61. Therefore, the operator will not attempt to pull out the optical transceiver module 1 in this state from the cage 2 by grasping the handle section 61.

### <During Unlocking>

FIG. 2B is a diagram illustrating a state of the movable mechanism 30 while being unlocked.

When the operator pushes the operating section 41 of the operating lever 40 to the rear with his/her finger, the tabs 42C go over the projection screws 72 and the operating lever 40 rotates about the head sections of the axis screws 71 that serve the axes of rotation. The tabs 42C are provided at positions closer than an end section of the operating section 41 of the operating lever 40 when seen from the axis holes 42A of the side face plates 42 and thus can easily go over the head sections of the projection screws 72 when the operator pushes the operating section 41.

Since the claw sections 44 are located opposite the operating section 41 with respect to the axis holes 42A in the side face plates 42, the claw sections 44 move forward when the operator pushes the operating section 41 of the operating lever 40 with his/her finger. As the claw sections 44 move forward, the front ends of the claw sections 44 push the front edges of the notched sections 62A of the finger grip 60 and the finger grip 60 is pushed forward. Since the claw sections 44 are provided at positions closer to the axis holes 42A in the side face plates 42 than the end section of the operating section 41 of the operating lever 40, the finger grip 60 can be moved forward even if the operator pushes the operating section 41 with a weak force.

While the claw sections 44 are moving in the windows 52A of the slider 50 (between the state shown in FIG. 2A and the state shown in FIG. 2B), the claw sections 44 are not in contact with the edges of the windows 52A. Therefore, at the time the finger grip 60 has started moving forward, the slider 50 is moving yet. It is to be noted that, since a size in the front-rear direction of the notched section 62A of the finger grip 60 is smaller than a size in the front-rear direction of the window 52A of the slider 50, the finger grip 60 can be moved before the slider 50 starts moving.

In a state where the tabs 42C are going over the head section of the projection screw 72, the right and left tabs 42C are elastically deformed in such a manner that they are pushed out in the right-left direction, a returning force is acting. In this state, as the operator releases his/her finger from the operating lever 40, the tabs 42C move and slide on the head sections of the projection screws 72, the operating lever 40 slightly rotates, and the rotation of the operating lever 40 stops when the tabs 42C have come off the head sections of the projection screws 72. It is to be noted that since the pan head screws each having a rounded head section are used as the projection screws 72, the tabs 42C can easily slide on the head sections of the projection screws 72. Therefore, the position of the operating lever 40 is stable between the state in which the projection screws 72 are fitted into the slots 42B (see FIG. 2A) and the state in which the lower sides of the projection screws 72 and the upper edges of the tab 42C are in contact (see FIG. 2C) and is unstable between these states (a state in which the tabs 42C are situated at the head sections of the projection screws 72, e.g., see FIG. 2B).

As the claw sections 44 of the operating lever 40 come into contact with the front edges of the windows 52A as shown in FIG. 2B and as the operating lever 40 further rotates, the slider 50 starts to move forward. If the operator releases the finger from the operating lever 40 in a state shown in FIG. 2B that is a state in which the tabs 42C have almost gone over the projection screws 72, the tabs 42C move in a sliding manner toward the lower parts of the projection screws 72 and the operating lever 40 slightly rotates to a state shown in FIG. 2C and the slider 50 moves forward. Therefore, even in a state where the operating lever 40 is rotated rearward, it will not come to a state where it is unlocked. Also, in a case where the finger grip 60 is pushed forward and the operator can easily grasp the handle section 61, it will not come to an unlocked state.

### <After Unlocking>

FIG. 2C is a diagram illustrating a state of the movable mechanism 30 after being unlocked.

The operating lever 40 is rotated to its most rearward position. Therefore, the claw section 44 is at a foremost position in the range of movement in the front-rear direction. The upper edge of the tab 42C of the operating lever 40 is in contact with a lower side of the projection screw 72. In order for the operating lever 40 to rotate, the tab 42C needs to go over the projection screw 72 and thus the position of the operating lever 40 is stable in this state unless an external force is applied to the operating lever 40.

The slider 50 is located at its foremost position. The wedge sections 51A of the slider 50 are at positions that are more to the front side than the wedge receiving sections 12B and are unlatched from the latching sections 2A of the cage 2, and the operator can pull out the transceiver module 1 from the cage 2. Since the projected sections 51B at the lower side of the slider 50 are in contact with the rear edges of the slider holding sections 14A of the front lower cover 14, the slider 50 cannot move further to the front. Also, since the position of the operating lever 40 is stable in a state where the front edges of the claw sections 44 of the operating lever 40 and the front edges of the windows 52A of the slider 50 are in contact, the slider 50 is also stable at this position unless an external force is applied to the operating lever 40.

The finger grip 60 is also at its foremost position. The positions of the notched sections 62A of the finger grip 60 are restricted by the claw sections 44 of the operating lever 40. Since the position of the operating lever 40 is stable in this state, the finger grip 60 moves only to an extent of a clearance between the notched sections 62A and the claw sections 44 unless an external force is applied to the operating lever 40.

Since the finger grip 60 is at the foremost position, the handle section 61 of the finger grip 60 comes to a state where it is most spaced apart from the front face of the head section 13 of the housing 11. Therefore, the operator can easily grasp the handle section 61 with his/her thumb and index finger. Also, since the operating section 41 of the operating lever 40 is rotated to the rear side, the operating section 41 of the operating lever 40 will not be an obstacle and the operator can easily grasp the handle section 61 with his/her thumb and index finger. Thus, the operator can easily pull out the optical transceiver module 1 from the cage 2.

The displacement of the slider 50 may be small since it is only necessary to release engagement between the wedge sections 51A of the slider 50 and the latching sections 2A of the cage 2. On the other hand, the displacement of the finger grip 60 needs to be large since it is necessary to move the finger grip 60 forward for easy grasping of the handle section 61 by the operator. Therefore, in the present embodiment, a size in the front-rear direction of the notched section 62A of the finger grip 60 is smaller than a size in the front-rear direction of the window 52A of the slider 50. Thus, the finger grip 60 starts moving from a state shown in FIG. 2A whereas the slider 50 starts moving from a state shown in FIG. 2B (i.e., the finger grip 60 starts moving before the slider 50) and, as a result, the displacement of the finger grip 60 becomes greater than the displacement of the slider 50.

### CONCLUSION

With the optical transceiver module of the present embodiment, since unlocking is achieved by rotating the operating lever 40 rearward, the optical fiber extending from the front side of the optical transceiver module 1 will not be an obstacle during unlocking.

Also, with the finger grip 60 being provided, since the finger grip 60 moves forward and apart from the front face of the housing 11 during unlocking, it becomes easier for the operator to pull out the optical transceiver module 1 from the cage 2. Particularly, since the displacement of the finger grip 60 during unlocking is greater than the displacement of the slider 50, the operator can easily pull out the optical transceiver module 1 from the cage 2.

Also, since the position of the operating lever 40 is restricted by the tabs 42C and the projection screws 72, it will not be unlocked while in a state where the operator can easily grasp the handle 61.

Also, since the axis of rotation and the protrusion of the operating lever 40 are made of screw by the axis screw 71 and the projection screw 72, an operation of attaching the movable mechanism 30 to the housing 11 and forming the projection to the housing 1 becomes easier.

Also, since a pan head screw is used as the projection screw 72 and the head section of the screw is rounded, the tab 42C can go over the head section of the screw more easily and the tab 42C can slide on the head section of the screw more easily.

Also, by manufacturing the optical transceiver module in accordance with an assembling process of the optical transceiver module of the present embodiment, it becomes easier to manufacture the optical transceiver module that can be easily inserted into and removed from the cage.

### ===Others===

It should be understood that the embodiments described above are only for facilitating the understanding of the invention and should not be interpreted as a limitation to the invention. It goes without saying that any changes and modifications to the present invention can be made without departing from the spirit and scope of the invention and that any equivalents are within the scope of the invention. Particularly, embodiments described below are within the scope of the invention.

### <Optical Transceiver>

The embodiment described above has been described with reference to the optical transceiver module 1 of an XFP type but it is not limited to such type. In an optical transceiver module of other types (such as an SFP type) too, an optical fiber extending from the front side of the optical transceiver module will not be an obstacle during unlocking if unlocking can be achieved by rotating the operating lever 40 rearward.

### <Optical Fiber>

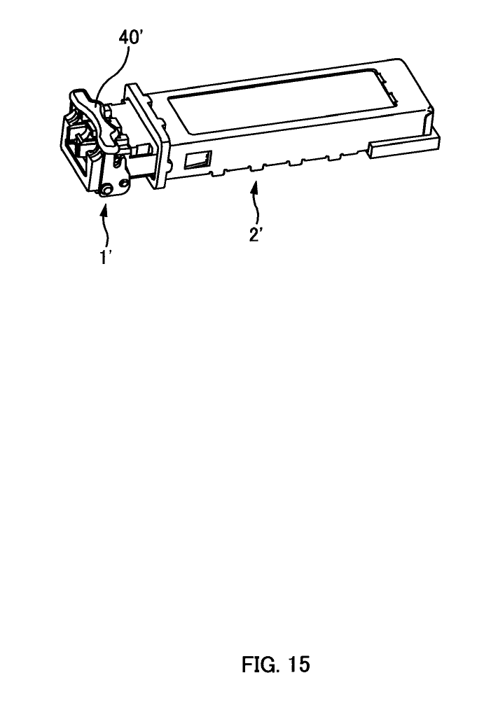

In the embodiment described above, the optical transceiver module 1 has been described as a pigtail type (a type in which an optical fiber is directly extending from the optical transceiver module), but may also be a type in which the optical fiber can be pulled out from the optical transceiver module by means of an optical connector, as shown in FIG. 15. Even in the optical transceiver module of a receptacle type shown in FIG. 15, the optical transceiver module can be pulled out from the cage with the optical fiber being attached. It is particularly advantageous in a case where the movable mechanism 30 described above is used in an optical transceiver module whose optical fiber is not removable, such as the optical transceiver module 1 of a pigtail type.

Also, in the embodiment described above, an optical fiber for bi-directional communication has been described but it is not limited thereto. Two optical fibers which are an optical fiber for receiving and an optical fiber for transmitting can be attached to the optical transceiver module 1.

Also, in the embodiment described above, an optical connector 21 at the end section of the optical fiber is an SC connector, but the type of connector is not limited thereto. For example, an FC connector, an LC connector, an MU connector, an ST connector and an MTRJ connector may be used and other connectors may also be used.

### <Window 52A>

In the embodiment described above, the slider 50 is provided with the window 52A. However, the shape of a section that is in contact with the claw section 44 of the operating lever 40 (slide-side contact member) is not limited thereto. For example, instead of the window 52A of the slider 50, the slider 50 may be provided with a contact section of a recessed shape formed therein that opens to the lower side, such as the notched section 62A of the finger grip 60.

### <Finger Grip 60>

In the embodiment described above, the movable mechanism 30 is provided with the finger grip 60. However, the movable mechanism 30 may include only the operating lever 40 and the slider 50. Even with this configuration, since unlocking can be achieved by rotating the operating lever 40 lever rearward, the optical fiber extending from the front of the optical transceiver module 1 will not be an obstacle. Also, in a case where the movable mechanism 30 includes only the operating lever 40 and the slider 50, the operator may grasp the head section 13 of the optical transceiver module 1 that has been unlocked and pull out the optical transceiver module 1 from the cage 2. It is preferable that the finger grip 60 is provided since it facilitates the operator to pull out the optical transceiver module 1 from the cage 2.

Also, in the embodiment described above, the displacement of the finger grip 60 is greater than the displacement of the slider 50. However, it is not limited thereto. Both displacements may be the same or the displacement of the slider 50 may be greater than the displacement of the finger grip 60. It is to be noted that the displacement of the finger grip 60 is preferably greater than the displacement of the slider 50 since the operator can easily pull out the optical transceiver module 1 from the cage 2.

### <Contact Between Claw Section 44 and Window 52A>

In the embodiments described above, the operating lever 40 is provided with the claw section 44 that serves as a lever-side contact section and the slider 50 is provided with the window 52A that serves as a slide-side contact section. However, the operating lever 40 may be provided with a window and the slider 50 may be provided with a projected section corresponding to the claw section 44.

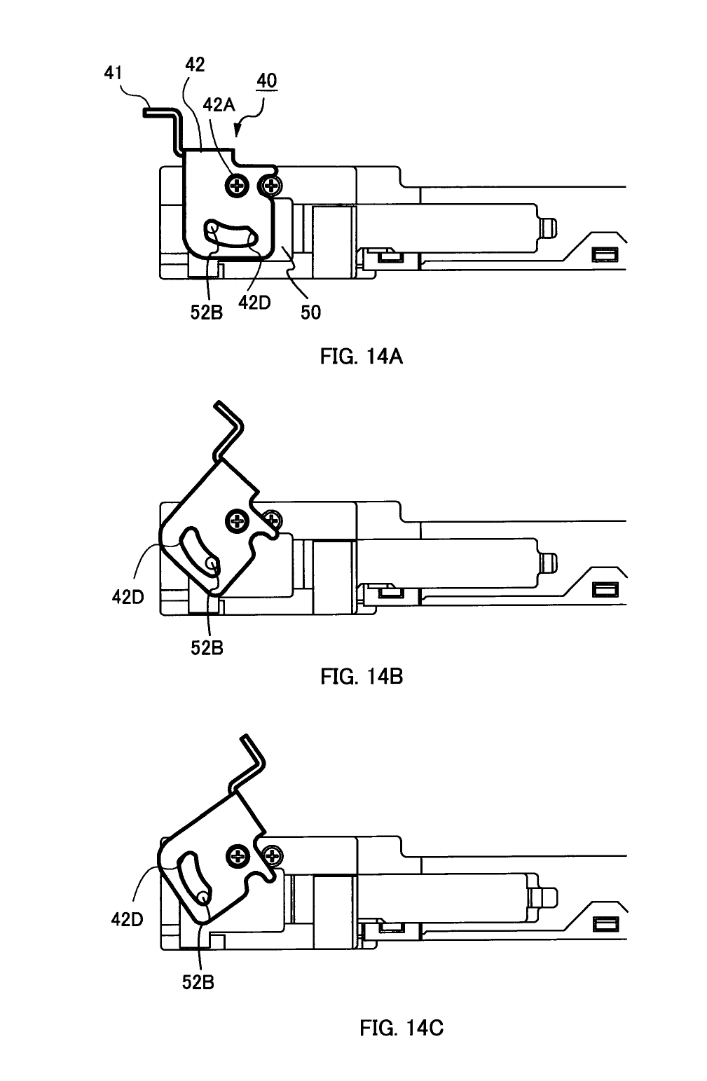

FIGS. 14A to 14C are diagrams illustrating variants. FIG. 14A is a diagram illustrating a state of a movable mechanism while being locked. FIG. 14B is a diagram illustrating a state of the movable mechanism while being unlocked. FIG. 14C is a diagram illustrating a state of the movable mechanism after being unlocked. In these figures, the operating lever is indicated with thick lines to facilitate the explanation. In this variant, the finger grip 60 is omitted.

The side face plate 42 of the operating lever 40 is provided with the window 42D. The window 42D is located opposite the operating section 41 with respect to the axis hole 42A of the side face plate 42. Therefore, as the operator pushes the operating section 41 of the operating lever 40 with his/her finger to the rear, the rear edge of the window 42D moves forward. Also, the side face of the slider 50 is provided with a pin 52B that projects outwards. The pin 528 of the slider 50 is located in such a manner that it enters into the window 42D of the operating lever 40.

As shown in FIG. 14A, while being locked, a front edge of the window 42D of the operating lever 40 and a front edge of the pin 52B of the slider 50 are in contact. As shown in FIG. 14B, during unlocking, as the operating lever 40 is pushed, the rear edge of the window 42D of the operating lever 40 comes into contact with the pin 52B and, as the operating lever 40 further rotates, the rear edge of the window 42D of the operating lever 40 pushes the pin 52B forward and the slider 50 moves forward.

In this manner, by providing the operating lever 40 with the window 42D and providing the slider 50 with the pin 52B, the slider can be moved forward by pushing the operating section of the operating lever 40 rearward.

### <Axis Screw 71>

In the embodiment described above, the operating lever 40 is provided with the axis hole 42A and the operating lever 40 is rotatably attached to the housing 11 by the axis screw 71 via the axis hole 42A. However, in rotatably attaching the operating lever 40 to the housing 11, it is not necessary to use the axis screw 71.

For example, instead of providing the housing 11 with the first protruding section 13B, the operating lever 40 may be rotatably attached to the housing 11 by providing a projecting section in advance that protrudes more outwardly than the first protruding section 13B and that has a size that can be inserted into the axis hole 42A and fitting the axis hole 42A of the operating lever 40 to this projecting section. However, in this case, since the projecting section of the housing needs to be fitted to the axis hole 42A while pushing the right and left side face plates 42 of the operating lever 40 outwards, it becomes more difficult to attach the movable mechanism 30 to the housing 11.

Also, instead of the axis hole 42A of the operating lever 40, the operating lever 40 may be rotatably attached to the housing 11 by providing a projection that protrudes inwardly from an inner surface of the side face plate 42 of the operating lever 40 and fitting this projection to the hole of the first protruding section 13B of the housing. However, in this case too, the right and left side face plates 42 of the operating lever 40 needs to be pushed outwards and it becomes more difficult to attach the movable mechanism 30 to the housing 11.

Also, in the embodiment described above, a pan head screw has been used as the axis screw 71, but other screws may be used.

### <Projection Screw 72>

In the embodiment described above, the projection screw 72 is attached to the housing 11 after having attached the movable mechanism 30 to the housing 11. However, it is not limited thereto and the side face of the housing 11 may be, for example, configured as a shape having a projection.

Also, in the embodiment described above, a pan head screw has been used as the projection screw 72, but other screws may be used. It is to be noted that it is preferable to use a screw with a rounded head section.

What is claimed is:

1. An optical transceiver module that is capable of being inserted into and removed from a cage, the optical transceiver module comprising:
a housing that houses a photoelectric conversion element, the housing having a guiding section formed along a front-rear direction;
an operating lever that has an operating section and a lever-side contact section, the operating lever being attached to the housing in a rotatable manner about an axis of rotation; and
a slider that has a wedge section that engages with a latching section provided to the cage and a slider-side contact section that comes into contact with the lever-side contact section, the slider being guided in the front-rear direction by the guiding section,
the lever-side contact section being located opposite the operating section with respect to the axis of rotation,
wherein, as the operating section is pushed rearward, the lever-side contact section pushes the slider-side contact section forward and the slider moves forward to a position where the wedge section is unlatched from the latching section.

2. The optical transceiver module according to claim 1, wherein,
the lever-side contact section is a claw section having a projected shape,
the slide-side contact section is a window through which the claw section has been entered, and,
as the operating section is pushed rearward, the claw section pushes the window and the slider moves forward to a position at which the wedge section is unlatched from the latching section.

3. The optical transceiver module according to claim 1, further comprising a finger grip having a handle section,
wherein, as the operating section is pushed rearward, the finger grip moves forward by being pushed by the lever-side contact section and the handle section moves away from the housing.

4. The optical transceiver module according to claim 3, wherein a displacement of the finger grip as the operating section is pushed rearward is greater than a displacement of the slider.

5. The optical transceiver module according to claim 3, wherein the housing is provided with a projection,
the operating lever being provided with a tab that goes over the projection while the operating lever is being rotated from a position where the wedge section is engageable with the latching section to a position where the wedge section is unlatched from the latching section,
the tab being located on the projection while in a state where the operating section is pushed rearward and the lever-side contact section is pushing the finger grip whereas the lever-side contact section is not pushing the slider.

6. The optical transceiver module according to claim 5, wherein the projection is a screw that is attached to the housing.

7. The optical transceiver module according to claim 6, wherein a head section of the screw is rounded.

8. The optical transceiver module according to claim 1, wherein the operating lever has an axis hole and the operating lever is attached to the housing by a screw attached to the housing via the axis hole, the screw serving as the axis of rotation.

9. A method of manufacturing an optical transceiver module that is capable of being inserted into and removed from a cage, the method comprising:
A) preparing a housing that houses a photoelectric conversion element, an operating lever that has an operating section, a lever-side contact section and an axis hole, and a slider that has a wedge section and a slider-side contact section,
the housing having a screw hole and a guiding section, the guiding section being formed along a front-rear direction,
the lever-side contact section being located opposite the operating section with respect to the axis hole,
the wedge section engaging with a latching section provided to the cage, the slider-side contact section coming into contact with the lever-side contact section;
B) assembling the operating lever and the slider in such a manner that the lever-side contact section and the slider-side contact section can come into contact with each other;
C) positioning the operating lever and the slider with respect to the housing with the axis hole and the screw hole being positioned with each other, the slider being guided in the front-rear direction by the guiding section; and
D) attaching a screw to the screw hole through the axis hole and attaching the operating lever to the housing in a rotatable manner about the screw.
